(19) United States
(12) Patent Application Publication
(10) Pub. No.: US 2004/0090936 A1
(43) Pub. Date: May 13, 2004

(54) Method and system for reducting traffic flow to a mobile node during handoff situations

(76) Inventors: Renaud Cuny, Espoo (FI); Jussi Ruutu, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/471,727

(22) PCT Filed: Mar. 16, 2001
(86) PCT No.: PCT/EP01/03039

(51) Int. Cl. H04L 12/56

(52) U.S. Cl. 370/331; 370/401

(57) ABSTRACT

The invention relates to a method and system for reducing traffic flow from a sending network element to a mobile element during handoff situations when the connection of the mobile element is switched, or to be switched, over from a first network access element to a second network access element. When the mobile element detects, or is informed on, a handoff process to be initiated, a procedure is initialised for reducing the traffic flow from the sending network element to the mobile element. The procedure for reducing the traffic flow preferably comprises employing an optimization process, preferably a TCP optimization process, e.g. delaying the sending of an acknowledgement message from the mobile element to the sending network element, or to reduce the value of the field “advertised window” of the acknowlegdement message to a smaller value than the actually appropriate value.

### FIELD AND BACKGROUND OF THE INVENTION

Mobile networks preferably provide seamless communication also during handoff when e.g. a moving mobile node changes from one cell to another cell. Such a seamless handoff suppresses any disturbances of the communication and is performed e.g. by mobility management.

Multicast and buffering are preferred methods to provide seamless handoff.

In the multicast solution, every Mobile Node (MN) has a unique multicast address and packets destinated to MNs have this multicast destination address. When a MN initiates a handoff with a new Access Point (AP), the new AP is already in the multicasting address of the MN. Thus, the handoff can be made seamless. A drawback of this solution is that multicasting has to be supported by the router and part of the network bandwidth is occupied since the data stream has to be duplicated to several Access Points.

In the buffering solution, a Foreign Agent (FA) buffers packets for the MN. When the MN switches FAs, the old FA has to send the buffered packets to the new FA which then forwards the packets to the MN. Packet buffer is required for every MN and in several APs. This increases the requirements for resources and decreases the scalability of the system.

Therefore, handoff handling mechanism such as multicast or buffering can have certain drawbacks related to waste of network bandwidth or scalability.

### SUMMARY OF THE INVENTION

The present invention provides a method, system and mobile or other network element as defined in the claims.

The method, system, and mobile or other network element are applicable in or to a communication network and/or data network and are adapted to reduce traffic flow from a sending network element to a mobile element during handoff conditions when the connection of the mobile element is switched, or to be switched, over from a first network access element to a second network access element. When the mobile element detects, or is informed on, a handoff condition, e.g. a handoff process to be initiated, the mobile or another network element initiates a procedure for reducing the traffic flow from the sending network element to the mobile element.

In accordance with a preferred implementation of the invention, for reducing traffic flow to, and also from, the mobile node, optimization methods such as TCP optimization methods may be used in the mobile or other network element (e.g. mobile node) in addition to the traditional handoff handling mechanism. In accordance with one embodiment of the invention, in order to reduce the necessary bandwidth or the requirement for ressources, the traffic flowing towards the MN is reduced before the handoff occurs or when initiating the handoff and/or during handoff. This procedure provides the additional advantage that the traffic flowing from the MN to the network is normally likewise reduced during handoff.

In mobile-assisted handoff or mobile-controlled handoff situations, the MN is aware of an imminent or actual handoff procedure and assists in handoff, or decides itself when to make handoff. When the MN detects an imminent or actual handoff procedure, it performs a process for reducing the traffic flowing to the MN, e.g. one or more of the above or below described processes.

In network-assisted or network-initiated handoff, the network may be adapted to send a message to the MN informing the latter on the hand-off, before or when initiating the handoff. When the MN receives this message, it performs a process for reducing the traffic flowing to the MN, e.g. one or more of the above or below described processes.

In case of TCP/IP traffic, TCP optimization methods may be performed in the MN before or when the handoff occurs in order to reduce the incoming traffic for the time necessary to achieve the handoff.

The TCP optimization methods that may be used in this case preferably are window pacing and/or fast-TCP.

When assuming that a MN receives some TCP traffic from the network, the MN sends back some TCP acknowledgements to its TCP peer in order to maintain the TCP connection. The TCP flow control mechanism specifies that the TCP sender must maintain a transmission window to limit traffic sent in the network. The size of this transmission window is the minimum of the congestion window or the advertised window size sent by the TCP reveiver. The congestion window is a variable that increases when a TCP acknowledgement is received from the TCP receiver. On the other hand, the expiration of a timer for TCP segment will cause the reduction of the size of congestion window. Thus, both the arrival or loss of acknowledgements received by the TCP sender have an influence on this congestion window value and thus on the sending rate.

Therefore, by modifying the content of the acknowledgement(s) or by delaying the returning of acknowledgement(s), the MN can influence the rate at which the TCP server will send traffic to the MN.

Such methods that use the characteristic of the TCP flow control mechanism to impact the rate of a TCP sender are known as TCP optimization methods.

In a window pacing scheme, the MN preferably reduces the advertised window field specified in the TCP acknowledgements to reduce the sending rate of the corresponding node.

In a fast-TCP scheme, the MN preferably delays the TCP acknowledgements for a short time in order to delay the time at which the corresponding sending node can send data.

The proposed solutions (such as window pacing or fast TCP) do not require any changes in the TCP protocol but rather use the characteristics of this protocol to influence the traffic rate of the sender. Only minimum implementation is needed to achieve this function. Especially, it is not necessary to modify the end hosts themselves, such as MN or TCP server, even though it is possible to apply the TCP optimisation methods also in those network elements if desired. If the window pacing method is used, the advertised window value of the TCP acknowledgements sent by the MN is systematically modified (e.g. drops to one segment) during the handoff period. The purpose is to make the TCP sender to drop its transmission rate and, thus, alleviate the problems during handoff period.

For Fast TCP, before or at handoff, the outgoing traffic rate (traffic carrying acknowledgements) will drop, in the above described solution, before the incoming traffic rate drops. This is achieved by delaying the TCP acknowledgements which delays the new TCP segments to be transmitted by the TCP sender. In normal situations the outgoing rate would be reduced only if the incoming rate is reduced.

Further details, aspects and advantages of the invention will be described below with reference to specific embodiments and the attached drawings.

### BRIEF DESCRIPTION OF THE DRAWINGS

FIG. 1 shows an embodiment of a system in accordance with the present invention;

FIG. 2 illustrates an embodiment of a method and system in accordance with the present invention in which the window pacing method is used; and

FIG. 3 shows a further embodiment of a method and system in accordance with the present invention in which fast-TCP is used.

### DESCRIPTION OF PREFERRED EMBODIMENTS OF THE INVENTION

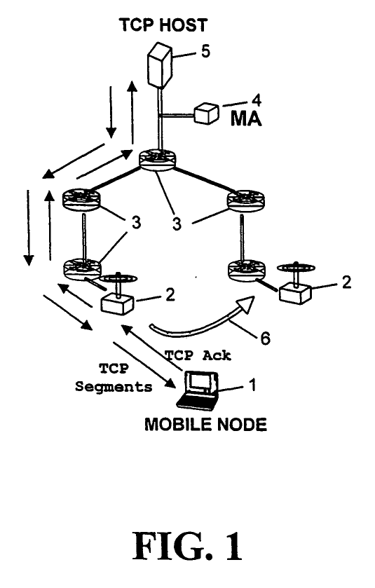

FIG. 1 shows an embodiment of the invention which includes a mobile element, e.g. Mobile Node (MN) 1 such as a portable computer or mobile station (MS), several base stations 2 serving as network access elements, several routers 3 of the communication networks and a Mobile Agent (MA) 4. Further, FIG. 1 illustrates a handoff situation caused by movement of MN 1 from the cell covered by the base station shown in the left part of the drawing, to the cell covered by the other base station 2. This handoff may also be an intra-cell handoff instead of an inter-cell handoff and is represented by the curved arrow 6 shown in FIG. 1.

In case of TCP traffic, the MN 1 receives TCP segments from, and sends some TCP acknowledgements (TCP Ack) to a host 5 as shown in FIG. 1.

Optimization methods like window pacing or fast TCP can be used in handoff situations. The network capacity can be saved efficiently by reducing the traffic, e.g. TCP traffic, during the handoff period. The methods proposed (e.g. window pacing and fast TCP) are easy to implement and do not require any modification of the TCP protocol.

The TCP optimization methods used in accordance with the preferred embodiments reduce the rate at which the TCP host sends data to the MN 1, e.g. by modifying or delaying the acknowledgement returned to the sending host 5.

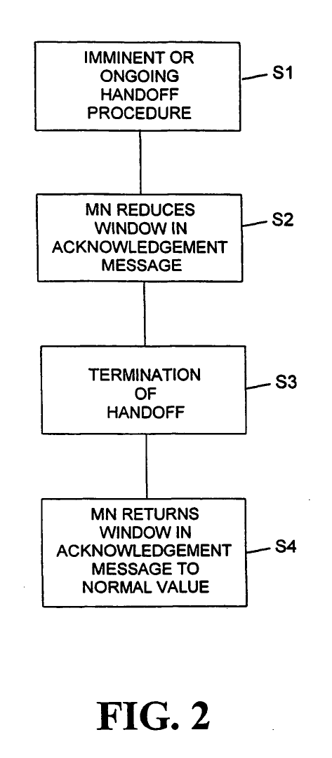

FIG. 2 illustrates a case of window pacing in which the MN 1 sends, in the acknowledgement message, a field “advertised window” which normally reflects the free buffer space available in the MN 1 for buffering further packets. When the free buffer space is high, the MN 1 normally increases the advertised window so as to allow the sender 5 to increase the data or packet rate sent to the MN 1. When the free buffer space becomes lower, the MN 1 decreases the advertised window so as to cause the sender to decrease the data or packet rate sent to the MN 1. When the MN 1 detects, or is informed on, a handoff procedure which is to be initiated or already going on (step S1 of FIG. 2), it checks, before sending a packet, if this packet is a TCP acknowledgement to be sent to the sending TCP host. If yes, the MN 1 reduces (sets) the advertised window field of this and all further acknowledgement packet(s) to a value lower than the one which would normally be sent for correctly reflecting the free buffer space (Step S2). The MN 1 preferably reduces the advertised window field to a minimum value (e.g. 1 segment) so as to drastically reduce the packet rate subsequently sent from the host 5 to the MN 1 but still maintain some slow communication flow.

The handoff procedure which is to be initiated or already going on can be determined by inspecting radio quality e.g. radio reception level. It can also be envisioned that the handoff procedure is only initiated at a certain probability at a certain radio quality threshold. However, in an embodiment of the invention there can be additional radio quality thresholds, the lowest quality threshold implying a need to actually perform the handoff. There can be upper thresholds for only reducing the traffic, the thresholds defining the reduction as a function of radio quality. This means that at the first threshold the traffic is reduced and at a following threshold the handoff is actually performed. In this embodiment of the invention, the traffic reduction is ensured prior to actual handoff. After the handoff, the traffic can be increased either immediately to maximum or gradually in accordance with the radio quality levels measured. “Handoff procedure” is the actual process where the connection of the mobile element is switched over from a first network access element to a second network access element. The handoff situation and handoff conditions are the actual temporally varying conditions relating to, for instance, the mobile element position, radio network receiving and transmission quality levels at various physical positions and the movement of the mobile element. These conditions may give an indication of need to perform handoff procedure. The conditions can also act as a pre-warning of a handoff procedure likely to be actually initiated in near future.

The MN 1 may also, in another embodiment, reduce the advertised window field to a zero value so as to largely or completely suppress the sending of packets to the MN 1 during handoff. The MN 1 then sends the acknowledgement including this reduced advertised window (field or segment in the acknowledgement message) to the host 5.

When the MN 1 subsequently detects, or is informed on, termination of the hand-off (Step S3), it resets the advertised window field to the normal value depending on the actual buffer size or the like so that the sending of packets to the MN 1 is returned to the normal traffic rate (Step S4).

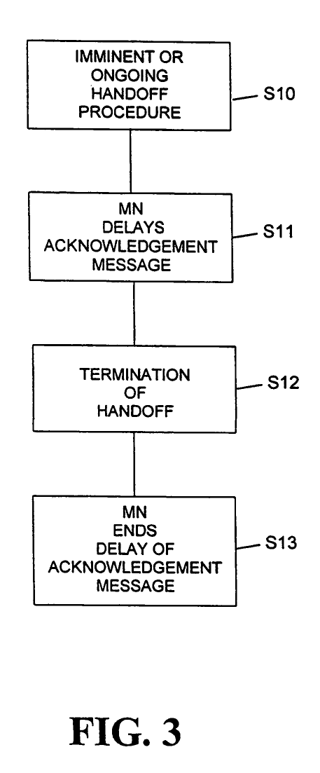

FIG. 3 illustrates a case of fast-TCP in which the MN 1 sends an acknowledgement message to the sending element after receipt of each packet. After receipt of the acknowledgement message, the sending element will send a next packet to the MN1 if present.

In this case of fast-TCP, instead of modifying the acknowledgement as in the FIG. 2 embodiment, the MN 1 will keep the acknowledgement message longer in its outgoing buffer before sending it, that is the MN 1 delays the outputting of the acknowledgement.

The delay of the acknowledgement in the MN 1 is preferably not be too long (compared to the round trip time of the connection) otherwise the TCP sender will consider that some packets have been lost and will resend them. Several milliseconds to several tens of milliseconds of delay (e.g. 5 to 90 ms, with 20 to 60 ms being preferred) are preferred and are suffficient to slow down the bitrate of the TCP sender.

When the MN 1 detects, or is informed on, a handoff situation requiring a handoff procedure which is to be initiated or already going on (step S10 of FIG. 3), it checks, before sending a packet, if this packet is a TCP acknowledgement to be sent to the sending TCP host. If yes, the MN 1 delays the sending of this and all further acknowledgement packet(s) by an appropriate delay time, i.e. delays the sending when. compared to the normal sending time point (Step S11).

When the MN 1 subsequently detects, or is informed on, termination of the hand-off (Step S12), it cancels the delay so that the sending of acknowledgement packets to the MN 1 is returned to the normal traffic rate without any artificial delay (Step S13)

The teaching according to the invention may be employed in networks of various types, i.e. in IM, GPRS and UMTS domains.

Although the invention has been described above with reference to specific embodiments, the scope of protection of the invention intends to cover all modifications, omissions, additions and amendments of the disclosed features as well. Especially it should be noticed that the present invention may be applied not only at the Mobile Node but also at the network side, such as at base station, at mobile agent or some other network element.

1. Method for reducing traffic flow from a sending network element to a mobile element during handoff conditions when the connection of the mobile element is switched, or to be switched, over from a first network access element to a second network access element, wherein, when the mobile element or another network element detects, or is informed on, a handoff condition, the mobile element or another network element initiates a procedure for reducing the traffic flow from the sending network element to the mobile element.

2. Method according to claim 1, wherein the traffic flow is a TCP traffic flow.

3. Method according to claim 1 or 2, wherein the procedure for reducing the traffic flow comprises employing an optimization process, preferably a TCP optimization process.

4. Method according to any one of the preceding claims, wherein the procedure for reducing the traffic flow comprises delaying sending of an acknowledgement message to the sending network element.

5. Method according to claim 4, wherein the mobile or another network element comprises an output buffer for storing acknowledgement messages to be sent, and the mobile or another network element delays the outputting of an acknowledgement message from the output buffer for sending it to the sending network element.

6. Method according to claim 4 or 5, wherein the mobile or another network element delays the sending of the acknowledgement message for several to several tens of milliseconds.

7. Method according to any one of the preceding claims, wherein an acknowledge message to be sent from the mobile element to the sending network element comprises a field “advertised window” which informs the sending network element on the buffer space available in the mobile element for receiving packets from the sending network element, and the procedure for reducing the traffic flow comprises indicating, in the field “advertised window”, a buffer space which is smaller than the actually available buffer space.

8. Method according to claim 7, wherein the value indicated in the field “advertised window” is set to one for reducing the traffic flow to the mobile element.

9. Method according to claim 7, wherein the value indicated in the field “advertised window” is set to zero for suppressing the traffic flow to the mobile element during handoff.

10. System adapted to reduce traffic flow from a sending network element to a mobile element during handoff conditions when the connection of the mobile element is switched, or to be switched, over from a first network access element to a second network access element, wherein the mobile element or another network element is adapted to initiate, when the mobile element or another network element detects, or is informed on, a handoff condition, a procedure for reducing the traffic flow from the sending network element to the mobile element.

11. System according to claim 10, wherein the traffic flow is a TCP traffic flow.

12. System according to claim 10 or 11, wherein the procedure for reducing the traffic flow comprises employing an optimization process, preferably a TCP optimization process.

13. System according to any one of the preceding system claims, wherein the procedure for reducing the traffic flow comprises delaying sending of an acknowledgement message to the sending network element.

14. System according to claim 13, wherein the mobile or other network element comprises an output buffer for storing acknowledgement messages to be sent, and the mobile or other network element is adapted to delay the outputting of an acknowledgement message from the output buffer for sending it to the sending network element.

15. System according to claim 13 or 14, wherein the mobile or other network element is adapted to delay the sending of the acknowledgement message for several to several tens of milliseconds.

16. System according to any one of the preceding system claims, wherein an acknowledge message to be sent from the mobile element to the sending network element comprises a field “advertised window” which informs the sending network element on the buffer space available in the mobile element for receiving packets from the sending network element, and the procedure for reducing the traffic flow comprises indicating, in the field “advertised window”, a buffer space which is smaller than the actually available buffer space.

17. System according to claim 16, wherein the value indicated in the field “advertised window” is set to one for reducing the traffic flow to the mobile element.

18. System according to claim 16, wherein the value indicated in the field “advertised window” is set to zero for suppressing the traffic flow to the mobile element during handoff.

19. Mobile or other network element, preferably for use in a method as defined in any one of the preceding method claims, or as defined in any one of the preceding system claims, said mobile or other network element being adapted to reduce traffic flow from a sending network element to the mobile element during handoff conditions when the connection of the mobile element is switched, or to be switched, over from a first network access element to a second network access element, wherein the mobile or other network element is adapted to initiate, when the mobile or other network element detects, or is informed on, a handoff condition, a procedure for reducing the traffic flow from the sending network element to the mobile element.

20. Mobile or other network element according to claim 19, wherein the traffic flow is a TCP traffic flow.

21. Mobile or other network element according to claim 19 or 20, wherein the procedure for reducing the traffic flow comprises employing an optimization process, preferably a TCP optimization process.

22. Mobile or other network element according to any one of the preceding claims 19 to 21, wherein the procedure for reducing the traffic flow comprises delaying sending of an acknowledgement message to the sending network element.

23. Mobile or ether network element according to claim 22, wherein the mobile or other network element comprises an output buffer for storing acknowledgement messages to be sent, and the mobile or other network element is adapted to delay the outputting of an acknowledgement message from the output buffer for sending it to the sending network element.

24. Mobile or other network element according to claim 22 or 23, wherein the mobile or other network element is adapted to delay the sending of the acknowledgement message for several to several tens of milliseconds.

25. Mobile or other network element according to any one of the preceding claims 19 to 24, wherein an acknowledge message to be sent from the mobile element to the sending network element comprises a field “advertised window” which informs the sending network element on the buffer space available in the mobile element for receiving packets from the sending network element, and the procedure for reducing the traffic flow comprises indicating, in the field “advertised window”, a buffer space which is smaller than the actually available buffer space.

26. Mobile or other network element according to claim 25, wherein the value indicated in the field “advertised window” is set to one for reducing the traffic flow to the mobile element.

27. Mobile or other network element according to claim 25, wherein the value indicated in the field “advertised window” is set to zero for suppressing the traffic flow to the mobile element during handoff.
